(19) United States
(12) Patent Application Publication
(10) Pub. No.: US 2025/0077622 A1
(43) Pub. Date: Mar. 6, 2025

(54) DATA ACTIVE SELECTION AND ANNOTATION METHOD AND APPARATUS FOR POINT CLOUD

(71) Applicant: Shenzhen University, Guangdong (CN)

(72) Inventors: Hui HUANG, Shenzhen (CN); Guoqing YANG, Shenzhen (CN); Wentao LAI, Shenzhen (CN)

(21) Appl. No.: 18/457,947

(22) Filed: Aug. 29, 2023

(30) Foreign Application Priority Data
Jul. 1, 2022 (CN) 202210764315.8

(51) Int. Cl. G06F 18/241; G06T 19/00

(52) U.S. Cl. CPC G06F 18/241; G06T 19/00; G06T 2219/004

(57) ABSTRACT

A data active selection and annotation method for a point cloud includes: inputting initial point cloud data into a feature extraction model to extract a first feature of annotated point cloud data and a second feature of unannotated point cloud data, the initial point cloud data including the annotated point cloud data and the unannotated point cloud data; inputting the unannotated point cloud data into a classification model to obtain a classification result of the unannotated point cloud data; determining each piece of target point cloud data with a pseudo label identical to a real label from the unannotated point cloud data according to the classification result and the real label of the annotated point cloud data; filtering to-be-annotated point cloud data from each piece of target point cloud data according to the first feature, a second feature and the classification result of each piece of target point cloud data.

### CROSS REFERENCE TO RELATED APPLICATION

The present application is based on and claims priority to Chinese Patent Application with No. 202210764315.8, titled “Data Active Selection and Annotation Method and Apparatus for Point cloud”, and filed on Jul. 1, 2022, the content of which is expressly incorporated herein by reference in its entirety.

### TECHNICAL FIELD

The present disclosure relates to the field of data processing technology, and particularly to a data active selection and annotation method and apparatus for point cloud.

### BACKGROUND

With the continuous development of acquisition equipment such as a lidar, a depth camera, etc., three-dimensional point cloud data including rich geometric, shape and scale information becomes an important data form of spatial digital expression. The three-dimensional point cloud data refers to a set of vectors in a three-dimensional coordinate system.

However, the three-dimensional point cloud data is not only disordered, arranged irregularly, but also large in scale. At present, target point cloud data is manually filtered from the three-dimensional point cloud data to annotate the target point cloud data. However, the current selection of the three-dimensional point cloud data requires significant time and labor costs.

### SUMMARY

In view of this, as for the above technical problem, it is necessary to provide a data active selection and annotation method and apparatus for a point cloud which can reduce the time consumption and the labor cost

In the first aspect of the present disclosure, a data active selection and annotation method for a point cloud is provided, including: inputting initial point cloud data into a feature extraction model to extract a first feature of annotated point cloud data and a second feature of unannotated point cloud data, the initial point cloud data comprising the annotated point cloud data and the unannotated point cloud data; inputting the unannotated point cloud data into a classification model to obtain a classification result of the unannotated point cloud data; determining each piece of target point cloud data with a pseudo label identical to a real label from the unannotated point cloud data according to the classification result and the real label of the annotated point cloud data, the pseudo label being determined according to the classification result; filtering to-be-annotated point cloud data from each piece of target point cloud data according to the first feature, a second feature and the classification result of each piece of target point cloud data.

In an embodiment, the filtering the to-be-annotated point cloud data from each piece of target point cloud data according to the first feature, the second feature and the classification result of each piece of target point cloud data includes: determining a target feature distance between the second feature of each piece of target point cloud data and the first feature; filtering the to-be-annotated point cloud data from each piece of target point cloud data according to the target feature distance and the classification result.

In an embodiment, the filtering the to-be-annotated point cloud data from each piece of target point cloud data according to the target feature distance and the classification result includes: determining an information entropy value of each piece of target point cloud data according to the classification result of each piece of target point cloud data; determining an annotation value of each piece of target point cloud data according to the target feature distance and the information entropy value of each piece of target point cloud data; filtering the to-be-annotated point cloud data from each piece of target point cloud data according to the annotation value of each piece of target point cloud data.

In an embodiment, the filtering the to-be-annotated point cloud data from each piece of target point cloud data according to the annotation value of each piece of target point cloud data includes: filtering the to-be-annotated point cloud data from each piece of target point cloud data according to a first quantity of each piece of target point cloud data, a second quantity of the initial point cloud data, and the annotation value of each piece of target point cloud data.

In an embodiment, the filtering the to-be-annotated point cloud data from each piece of target point cloud data according to the first quantity of each piece of target point cloud data, the second quantity of the initial point cloud data, and the annotation value of each piece of target point cloud data includes: determining a ratio of the first quantity to the second quantity; determining a third quantity of the to-be-annotated point cloud data according to the ratio and a preset point cloud data annotation quantity threshold; and filtering the third quantity of to-be-annotated point cloud data from each piece of target point cloud data.

In an embodiment, the determining the target feature distance between the second feature of each piece of target point cloud data and the first feature includes: determining a feature distance between a second feature of each piece of target point cloud data and each first feature; determining a minimum feature distance corresponding to the second feature of each piece of target point cloud data, and determining the minimum feature distance as the target feature distance between the second feature and the first feature.

In an embodiment, the method further includes: inputting a point cloud data sample into a first encoding module to obtain first encoded data, and inputting the first encoded data into a first projection module to obtain a first normalized feature at a current iteration; performing coordinate transformation processing on the point cloud data sample to obtain a point cloud data sample processed by the coordinate transformation; inputting the point cloud data sample processed by the coordinate transformation into the second encoding module to obtain second encoded data, and inputting the second encoded data into a second projection module to obtain a second normalized feature at a current iteration; determining the first normalized feature and the second normalized feature as a positive example pair, and determining the first normalized feature and each second normalized feature obtained before the current iteration as a set of negative example pair; training the initial feature extraction model according to the positive example pair and the set of negative example pairs to obtain the feature extraction model.

In the second aspect of the present disclosure, a data active selection and annotation apparatus for a point cloud is provided, including: an extraction module, configured to input initial point cloud data into a feature extraction model to extract a first feature of annotated point cloud data and a second feature of unannotated point cloud data, the initial point cloud data comprising the annotated point cloud data and the unannotated point cloud data; a first obtaining module, configured to input the unannotated point cloud data into a classification model to obtain a classification result of the unannotated point cloud data; a determination module, configured to determine each piece of target point cloud data with a pseudo label identical to a real label from the unannotated point cloud data according to the classification result and the real label of the annotated point cloud data; a selection module, configured to filter to-be-annotated point cloud data from each piece of target point cloud data according to the first feature, a second feature and the classification result of each piece of target point cloud data.

In the third aspect of the present disclosure, a computer device is provided, which includes a processor and a memory storing a computer program, the processor, when executing the computer program, implements the steps of: inputting initial point cloud data into a feature extraction model to extract a first feature of annotated point cloud data and a second feature of unannotated point cloud data, the initial point cloud data comprising the annotated point cloud data and the unannotated point cloud data; inputting the unannotated point cloud data into a classification model to obtain a classification result of the unannotated point cloud data; determining each piece of target point cloud data with a pseudo label identical to a real label from the unannotated point cloud data according to the classification result and the real label of the annotated point cloud data, the pseudo label being determined according to the classification result; filtering to-be-annotated point cloud data from each piece of target point cloud data according to the first feature, a second feature and the classification result of each piece of target point cloud data.

In the fourth aspect of the present disclosure, a computer-readable storage medium is provided, on which a computer program is stored, the computer program, when executed by a processor, causes the processor to implement the steps of: inputting initial point cloud data into a feature extraction model to extract a first feature of annotated point cloud data and a second feature of unannotated point cloud data, the initial point cloud data comprising the annotated point cloud data and the unannotated point cloud data; inputting the unannotated point cloud data into a classification model to obtain a classification result of the unannotated point cloud data; determining each piece of target point cloud data with a pseudo label identical to a real label from the unannotated point cloud data according to the classification result and the real label of the annotated point cloud data, the pseudo label being determined according to the classification result; filtering to-be-annotated point cloud data from each piece of target point cloud data according to the first feature, a second feature and the classification result of each piece of target point cloud data.

According to the above-mentioned data active selection and annotation method and apparatus for the point cloud, the initial point cloud data is inputted into the feature extraction model to extract the first feature of the annotated point cloud data and the second feature of the unannotated point cloud data, and the unannotated point cloud data is inputted into the classification model to obtain the classification result of the unannotated point cloud data; each piece of target point cloud data with the pseudo label identical to the real label is determined from the unannotated point cloud data according to the pseudo label and the real label of the annotated point cloud data, and then the to-be-annotated point cloud data is filtered from each piece of target point cloud data according to the first feature, the second feature and the classification result of each piece of target point cloud data. Accordingly, the appropriate and most valuable point cloud data is filtered from the unannotated point cloud data as the to-be-annotated point cloud data through the active annotation strategy. Each piece of target point cloud data with the pseudo label identical to the real label is determined from the unannotated point cloud data by fully exploiting the feature of the initial point cloud data. Since the data volume of each piece of target point cloud data is less than the data volume of the unannotated point cloud data in the initial point cloud data, the to-be-annotated point cloud data can be quickly filtered from the target point cloud data with less data amount, so that the annotation time and the annotation cost of the point cloud data can be reduced, and the selection process does not require human participation, which can save the time and labor cost required for the whole selection process.

### BRIEF DESCRIPTION OF THE DRAWINGS

FIG. 1 is a flow chart showing a data active selection and annotation method for point cloud according to an embodiment of the present disclosure.

FIG. 2 is a flow chart showing a data active selection and annotation method for point cloud according to an embodiment of the present disclosure.

FIG. 3 is a flow chart showing a data active selection and annotation method for point cloud according to an embodiment of the present disclosure.

FIG. 4 is a flow chart showing a data active selection and annotation method for point cloud according to an embodiment of the present disclosure.

FIG. 5 is a flow chart showing a data active selection and annotation method for point cloud according to an embodiment of the present disclosure.

FIG. 6 is a flow chart showing a data active selection and annotation method for point cloud according to an embodiment of the present disclosure.

FIG. 7 is a schematic structure diagram of a feature extraction model according to an embodiment of the present disclosure.

FIG. 8 is a schematic diagram of a training architecture of a feature extraction model according to an embodiment of the present disclosure.

FIG. 9 is a schematic structure diagram of a classification model according to an embodiment of the present disclosure.

FIG. 10 is a schematic diagram illustrating a distribution of point cloud feature vectors in a mapping space according to an embodiment of the present disclosure.

FIG. 11 is a visual comparison diagram of segmentation effects of a point cloud segmentation task according to an embodiment of the present disclosure.

FIG. 12 is a ModelNet classification accuracy variation diagram with a random annotation and an annotation using a point cloud data selection model according to an embodiment of the present disclosure.

FIG. 13 is a ShapeNet mean accuracy variation diagram with a random annotation and an annotation using a point cloud data selection model according to an embodiment of the present disclosure.

FIG. 14 is a ShapeNet mean intersection over union variation diagram with a random annotation and an annotation using a point cloud data selection model according to an embodiment of the present disclosure.

FIG. 15 is a structure diagram illustrating a data active selection and annotation apparatus for point cloud according to an embodiment of the present disclosure.

FIG. 16 is an internal structure diagram of a computer device according to an embodiment of the present disclosure.

### DETAILED DESCRIPTION

In order to understand the purpose, the technical solution, and the advantages of the present disclosure more clearly, the present disclosure will be elaborated below with reference to accompanying drawings and embodiments. It should be appreciated that the specific embodiments described herein are merely illustrative of the present disclosure and are not intended to limit the present disclosure.

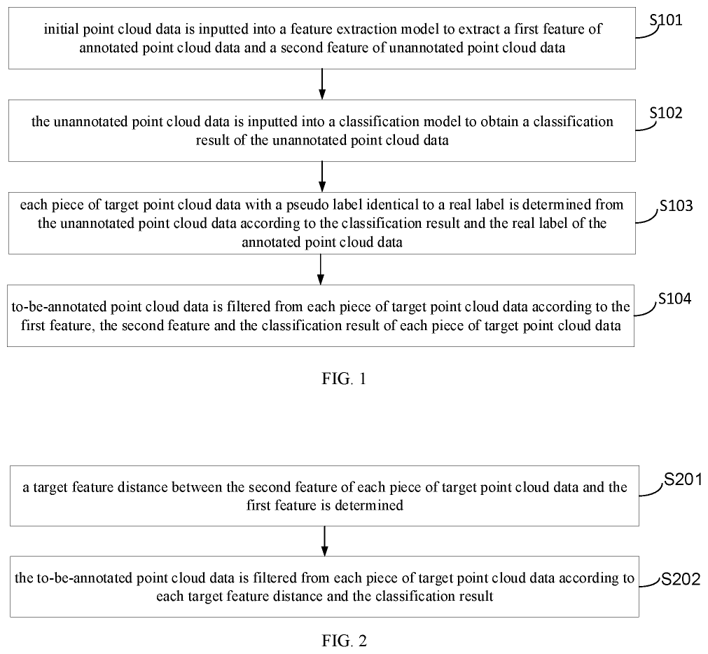

FIG. 1 is a flow chart showing a data active selection and annotation method for point cloud according to an embodiment of the present disclosure. In an embodiment, as shown in FIG. 1, the method is applied to a computer device as an example, and the method may include the following steps.

S101: initial point cloud data is inputted into a feature extraction model to extract a first feature of annotated point cloud data and a second feature of unannotated point cloud data.

The initial point cloud data includes annotated point cloud data and unannotated point cloud data. The first feature of the annotated point cloud data may be extracted, and the second feature of the unannotated point cloud data may be extracted.

The feature extraction model in the embodiment is a model obtained by training an initial comparative learning training model based on comparative learning. The initial comparative learning training model is a self-monitoring model, which can effectively extract features of the point cloud data and fully exploit features of the point cloud data.

S102: the unannotated point cloud data is inputted into a classification model to obtain a classification result of the unannotated point cloud data.

S103: each piece of target point cloud data with a pseudo label identical to a real label is determined from the unannotated point cloud data according to the classification result and the real label of the annotated point cloud data.

The pseudo label is determined according to the classification result. For example, when the classification result is (1/3, 2/3) which indicates that a probability of the unannotated point cloud data representing a sofa is 1/3, and a probability of the unannotated point cloud data representing a chair is 2/3, and the pseudo label of the unannotated point cloud data is the chair.

Since the accuracy of the classification model cannot be 100%, and the inputted point cloud data is the unannotated point cloud data, the accuracy of the classification result obtained by inputting the unannotated point cloud data into the classification model is not clear, and the label determined according to the classification result is a pseudo label.

In the embodiment, in order to select the unannotated point cloud data as evenly as possible, each piece of target point cloud data with a pseudo label identical to a real label is selected to form a to-be-annotated data set, and appropriate point cloud data is filtered from the to-be-annotated data set to perform the annotation.

S104: to-be-annotated point cloud data is filtered from each piece of target point cloud data according to the first feature, the second feature and the classification result of each piece of target point cloud data.

This step is an active annotation strategy. The active annotation strategy is not limited to a specific data set. By fully exploiting the features of the data set, the effect of approaching supervised learning in various point cloud tasks in the case with fewer annotations is implemented. The active annotation strategy can be effectively applied to different point cloud data sets and has a universality. The specific data set indicates that the point cloud data in the specific data set has a fixed data type.

Specifically, by the data active selection and annotation method for the point cloud in the present embodiment, the to-be-annotated point cloud data is filtered without manual selection. The method can save time and labor for manual selection. It should be noted that the filtered to-be-annotated point cloud data may be manually annotated, or may be annotated by another annotation mode.

According to the data active selection and annotation method for point cloud provided in the embodiment, the initial point cloud data is inputted into the feature extraction model to extract the first feature of the annotated point cloud data and the second feature of the unannotated point cloud data, and the unannotated point cloud data is inputted into the classification model to obtain the classification result of the unannotated point cloud data; each piece of target point cloud data with the pseudo label identical to the real label is determined from the unannotated point cloud data according to the pseudo label and the real label of the annotated point cloud data, and then the to-be-annotated point cloud data is filtered from each piece of target point cloud data according to the first feature, the second feature and the classification result of each piece of target point cloud data. Since the feature extraction model can fully exploit and extract the first feature of the annotated point cloud data and the second feature of the unannotated point cloud data, the unannotated point cloud data is inputted into the classification model to obtain the classification result of the unannotated point cloud data, each piece of target point cloud data with the pseudo label identical to the real label is determined from the unannotated point cloud data, and then the to-be-annotated point cloud data is filtered from each piece of target point cloud data according to the first feature, the second feature and the classification result of each piece of target point cloud data, so that the appropriate and most valuable point cloud data is filtered from the unannotated point cloud data as the to-be-annotated point cloud data through the active annotation strategy. Each piece of target point cloud data with the pseudo label identical to the real label is determined from the unannotated point cloud data by fully exploiting the feature of the initial point cloud data. Since the data amount of each piece of target point cloud data is less than the data amount of the unannotated point cloud data in the initial point cloud data, the to-be-annotated point cloud data can be quickly filtered from the target point cloud data with a smaller data amount, so that the annotation time and the annotation cost of the point cloud data can be reduced, and the selection process does not require human participation, which can save the time and labor cost required for the whole selection process.

FIG. 2 is a flow chart showing a data active selection and annotation method for point cloud according to another embodiment of the present disclosure. Referring to FIG. 2, the embodiment relates to an alternative implementation mode for filtering the to-be-annotated point cloud data from each piece of target point cloud data according to the first feature, the second feature and the classification result of each piece of target point cloud data. Based on the above embodiment, the step S104 may include the following steps.

S201: a target feature distance between the second feature of each piece of target point cloud data and the first feature is determined.

Since the target feature distance reflects a feature richness, the target feature distance between the second feature of each piece of target point cloud data and the first feature is determined, and then the to-be-annotated point cloud data is filtered from each piece of target point cloud data according to the target feature distance and the pseudo label, which can facilitate the completion of a target task. Specifically, the target task may be, but is not limited to, a point cloud segmentation task or a point cloud classification task.

Specifically, the target feature distance can be calculated by the following equation (1):

$${q}_{2} = dist ( {f}_{s} - {f}^{′} ) , \qquad ( 1 )$$

where fₛ is a first feature, f′ is a second feature, and q₂ represents a feature distance between the first feature and the second feature, and a target feature distance may be a maximum feature distance in the feature distances each of which is between the second feature of the target point cloud data and each first feature; alternatively, a result obtained by multiplying the maximum feature distance by a preset coefficient serves as the target feature distance.

S202: the to-be-annotated point cloud data is filtered from each piece of target point cloud data according to each target feature distance and the classification result.

In the present embodiment, the to-be-annotated point cloud data is filtered from each piece of target point cloud data according to the target feature distance and the classification result, so that an average degree and the information richness of the filtered unannotated point cloud data can be improved, thereby facilitating the completion of the target task of the point cloud.

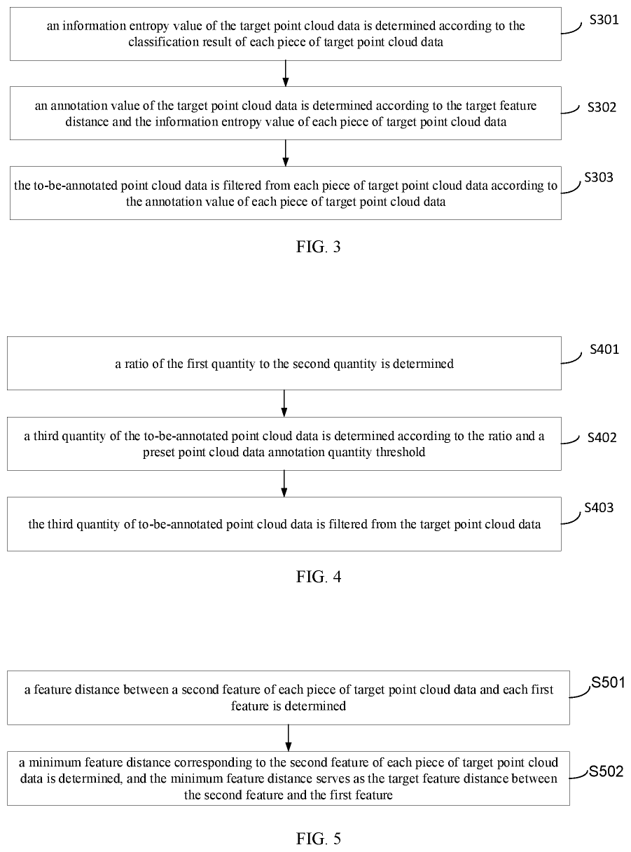

Referring to FIG. 3, FIG. 3 is a flow chart showing a data active selection and annotation method for point cloud according to another embodiment of the present disclosure. The embodiment relates to how to filter the to-be-annotated point cloud data from each piece of target point cloud data according to each target feature distance and the pseudo label. Based on the above embodiment, the step S202 may include the following steps.

S301: an information entropy value of the target point cloud data is determined according to the classification result of each piece of target point cloud data.

The information entropy value is configured to measure the amount of information included in the point cloud data. When the information entropy value is smaller, it indicates that the information amount of the point cloud data is sufficient. When the information entropy value is greater, it indicates that the point cloud data can be annotated as an uncertain sample.

Specifically, the information entropy value can be calculated by the following equation (2):

$${q}_{1} = - c * log ( c ) , \qquad ( 2 )$$

where c is the classification result, and q₁ represents the information entropy value.

Since the target feature distance reflects the feature richness, the maximum target feature distance is determined from various target feature distances, so that the feature richness can be reflected to the fullest extent.

S302: an annotation value of the target point cloud data is determined according to the target feature distance and the information entropy value of each piece of target point cloud data.

S303: the to-be-annotated point cloud data is filtered from each piece of target point cloud data according to the annotation value of each piece of target point cloud data.

The higher the annotation value of the point cloud data, the more it deserves to be annotated. Specifically, the annotation value can be calculated by the following equation (3):

$$q = {W}_{e} {q}_{1} + {W}_{d} {q}_{2} , \qquad ( 3 )$$

where q denotes the annotation value, and Wₑ and W_{d} are weight hyperparameters, both ranging from 0 to 1.

The annotation value of the unannotated point cloud data is determined according to the target feature distance and the information entropy value of each piece of target point cloud data, so that the to-be-annotated point cloud data is determined according to the annotation value, to annotate the point cloud data corresponding to the higher feature richness, and extend the information richness of the whole annotated point cloud data. Since point cloud data with the same label is adjacent to each other in the feature space, the target point cloud data with a larger target feature distance has more annotation value, that is, the greater the distance between the point cloud data corresponding to the pseudo label and the point cloud data corresponding to the real label is, the more annotation value the target point cloud data has.

In the embodiment, the annotation value of the target point cloud data is determined by the target feature distance and the information entropy value of each piece of target point cloud data, and then the to-be-annotated data is selected according to the annotation value, so that point cloud data most worth annotating can be selected from each piece of target point cloud data.

Optionally, the step of filtering the to-be-annotated point cloud data from each piece of target point cloud data according to the annotation value of the unannotated point cloud data in the step S303 may be implemented in the following mode:

the to-be-annotated point cloud data is filtered from each piece of target point cloud data according to a first quantity of each piece of target point cloud data, a second quantity of the initial point cloud data, and the annotation value of each piece of target point cloud data.

In the embodiment, the first quantity refers to the quantity of the unannotated point cloud data with the pseudo label identical to the real label; and the second quantity refers to the quantity of the initial point cloud data.

Referring to FIG. 4, FIG. 4 is a flow chart showing a data active selection and annotation method for point cloud according to another embodiment of the present disclosure. This embodiment relates to an alternative implementation mode for filtering the to-be-annotated point cloud data from each piece of target point cloud data according to the first quantity of each piece of target point cloud data, the second quantity of the initial point cloud data, and the annotation value of each piece of target point cloud data. Based on the above embodiments, the method may include the following steps.

S401: a ratio of the first quantity to the second quantity is determined.

S402: a third quantity of the to-be-annotated point cloud data is determined according to the ratio and a preset point cloud data annotation quantity threshold.

The preset point cloud data annotation quantity threshold is a quantity of point cloud data needing to be annotated in a specific category. In the embodiment, the third quantity may be specifically equal to the ratio times the preset point cloud data annotation quantity threshold.

Specifically, the to-be-annotated point cloud data can be calculated by the following equation (3):

$${k}_{c} = k * \frac{{N}_{c}}{N} , \qquad ( 3 )$$

where k is the preset point cloud data annotation quantity threshold, N_{c} is the quantity of the target point cloud data, i.e., the first quantity; N is the quantity of the initial point cloud data, i.e., the second quantity; and k_{c} is the third quantity of the to-be-annotated point cloud data.

S403: the third quantity of to-be-annotated point cloud data is filtered from the target point cloud data.

Specifically, the annotation values of the target point cloud data are arranged in an order from large to small, and then the third quantity of point cloud data is selected in an order from large to small, that is the finally selected point cloud data.

In the embodiment, the preset point cloud data annotation quantity threshold is the quantity of the point cloud data needing to be annotated in the specific category, so that the quantity of the point cloud data needing to be annotated in the specific category can be determined, a corresponding relationship between the quantity of the point cloud data needing to be annotated in the specific category and the annotation value obtained based on the classification result and the target feature distance is formed, and the optimal annotated point cloud data is filtered.

Referring to FIG. 5, FIG. 5 is a flow chart showing a data active selection and annotation method for point cloud according to another embodiment of the present disclosure. The embodiment relates to how to determine the target feature distance between the second feature of each piece of target point cloud data to the first feature. Based on the above embodiments, the step S201 may include the following steps.

S501: a feature distance between a second feature of each piece of target point cloud data and each first feature is determined.

In the actual selection process of the point cloud data, there are generally a plurality of pieces of annotated point cloud data, and there also exists a plurality of corresponding first features, and a plurality of distances from the second feature to all first features.

S502: a minimum feature distance corresponding to the second feature of each piece of target point cloud data is determined, and the minimum feature distance serves as the target feature distance between the second feature and the first feature.

In the embodiment, the target feature distance can be determined by comparing the feature distance between the second feature and each first feature, the smallest feature distance among the feature distances between the second feature and each first feature serves as the target feature distance between the second feature and the first feature, and all the first features can be considered as a whole, thereby determining the target feature distance between the second feature and the first feature.

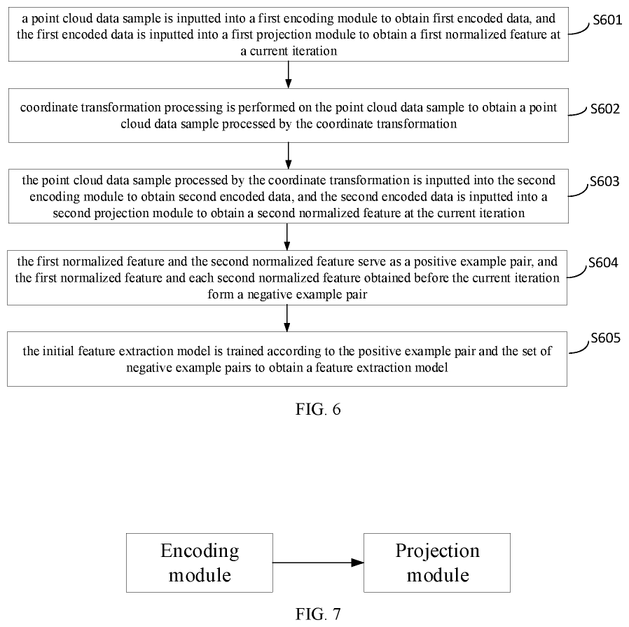

In order to be able to efficiently extract the features of the point cloud data, in a specific embodiment, the data active selection and annotation method for the point cloud may further include a process of obtaining the feature extraction model. Referring to FIG. 6, FIG. 6 is a flow chart showing a data active selection and annotation method for point cloud according to another embodiment of the present disclosure. Based on the above embodiments, the process of obtaining the feature extraction model may include the following steps.

S601: a point cloud data sample is inputted into a first encoding module to obtain first encoded data, and the first encoded data is inputted into a first projection module to obtain a first normalized feature at a current iteration.

The encoding module in the embodiment is the feature extraction module, and the projection module is a feature space projection module.

S602: coordinate transformation processing is performed on the point cloud data sample to obtain a point cloud data sample processed by the coordinate transformation.

S603: the point cloud data sample processed by the coordinate transformation is inputted into the second encoding module to obtain second encoded data, and the second encoded data is inputted into a second projection module to obtain a second normalized feature at the current iteration.

S604: the first normalized feature and the second normalized feature serve as a positive example pair, and the first normalized feature and each second normalized feature obtained before the current iteration form a negative example pair.

Specifically, an anchor sample (such as a first normalized feature) and a corresponding sample (such as a second normalized feature) needing to be pulled closer in the feature space form one positive example pair, and meanwhile the anchor sample and a plurality of corresponding samples (such as second normalized features) needing to be pulled away from each other in the feature space form a plurality of negative example pairs, and finally one positive example pair and a plurality of negative example pairs are utilized to calculate a corresponding loss to implement the pulling closer and pulling away in the feature space.

For example, a first normalized feature and a second normalized feature obtained for the first time are denoted as A1 and B1; a first normalized feature and a second normalized feature obtained for the second time are denoted as A2 and B2; a first normalized feature and a second normalized feature obtained for the third time are denoted as A3 and B3. If the current iteration is the third iteration, A3 and B3 form a positive example pair; A3 and B1, A3 and B2 form two negative example pairs, respectively, and the two negative example pairs form a set of negative example pairs.

S605: the initial feature extraction model is trained according to the positive example pair and the set of negative example pairs to obtain a feature extraction model.

The feature extraction model includes a feature extraction module, i.e., the first encoding module.

In the embodiment, the initial feature extraction model is trained according to the set of positive example pairs and the set of negative example pairs to obtain the feature extraction model; the set of positive example pairs and the set of negative example pairs are configured to perform the comparative learning training, so that the point cloud feature extraction model can be trained without a supervised signal, and finally the feature extraction module capable of effectively extracting features of point cloud data can be obtained.

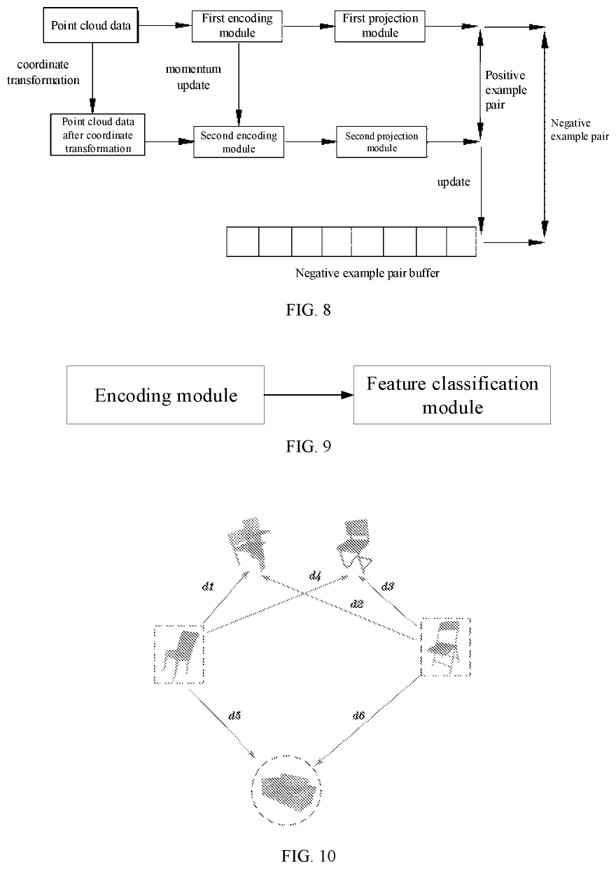

In a specific embodiment, according to the data active selection and annotation method for the point cloud, a point cloud data selection model may be formed. The point cloud data selection model consists of a feature extraction model, a classification model, and an active selection model. Referring to FIG. 7, FIG. 7 is a schematic structure diagram of a feature extraction model according to an embodiment of the present disclosure. In the embodiment, the feature extraction model includes an encoding module and a projection module. Referring to FIG. 8, FIG. 8 is a training architecture diagram of a feature extraction model. The training architecture of the feature extraction model in the embodiment is a comparative learning-based pre-training architecture improved according to the MoCo architecture, which includes an upper branch h₁ and a lower branch h₂, both of which have the same structure including an encoding module and a projection module. For ease of distinction, the encoding module of the branch h₁ is referred to as a first encoding module, the projection module of the branch h₁ is referred to as a first projection module. The encoding module of the branch h₂ is referred to as a second encoding module, and the projection module of the branch h₂ is referred to as a second projection module. The training architecture of the feature extraction model further includes a negative example pair buffer which is configured to store the second normalized feature outputted by the second projection module. Each normalized feature is stored in the negative example pair buffer. A first normalized feature outputted by the first projection module at the current iteration and each second normalized feature obtained before the current iteration form the set of negative example pairs. The design of the negative example pair buffer can improve the training effect of the feature extraction model. The first normalized feature outputted by the first projection module and the second normalized feature outputted by the second projection module serve as a positive example pair. A parameter of the second encoding module is updated with a momentum according to a parameter of the first encoding module.

It should be noted that the first normalized feature outputted by the first projection module at the current iteration and the second normalized feature outputted by the second projection module at the current iteration do not form a negative example pair. The second normalized feature stored in the negative example pair buffer and forming a negative example pair with the first normalized feature is the second normalized feature outputted by the second projection module before the current iteration.

The point cloud data inputted into the second encoding module is obtained by performing a coordinate transformation on the point cloud data inputted into the first encoding module. Specifically, the coordinate transformation may include, but is not limited to, a rotation, a translation, scaling, and random perturbation.

In the embodiment, the point cloud data inputted into the first encoding module is P₂, and P₂ is transformed into P₁ by the coordinate transformation; and P₁ and P₂ are respectively inputted into the branch h₁ and the branch h₂ to process. To facilitate training without loss of generality, a feature extraction portion of the PointNet is selected as the same encoding module in the branch h₁ and the branch h₂ in the embodiment, and three-dimensional coordinates of the inputted point cloud data are expanded to point-by-point features of 64, 128 and 1024 dimensions, respectively. The point-by-point features extracted by the encoding module are then respectively inputted into the projection modules in the branch h₁ and the branch h₂ to process in order to be further projected to the feature space to obtain the first normalized feature and the second normalized feature, respectively.

When the feature extraction model in the embodiment is performed, the PointInfo loss is also calculated in the normalized feature space, and a reverse transmission is performed to train the model. The parameter θₕ₁ of the upper branch h₁ is updated through the reverse transmission, and the parameter θₕ₂ of the lower branch h₂ is updated with the momentum according to the parameter of the upper branch h₁. The momentum update formula is as follows:

$${θ}_{h 2} ← m {θ}_{h 2} + ( 1 - m ) {θ}_{h 1} ,$$

where m is a super parameter satisfying 0<m<1.

The model parameters obtained after training are fixed and are configured to select point cloud data to be annotated in the subsequent active learning strategy process. A specific form of a loss function for calculating the PointInfo loss is as follows:

$${L}_{c} = - {\sum }_{( i , j ) ∈ {P}_{o}} log \frac{exp ( {f}_{i} * \frac{{f}_{j}}{τ} )}{{\sum }_{( . , k )} ∈ {N}_{e} exp ( {f}_{i} * \frac{{f}_{j}}{τ} )} ,$$

where Pₒ is a set of positive example pairs, Nₑ is a set of negative example pairs. Subscripts i and j represent different transform features of the same point cloud data; fᵢ and fⱼ form a positive example pair; fᵢ and fₖ form a negative example pair; t is a temperature parameter configured to control proportions of the positive example pairs and negative example pairs involved in the calculation.

Specifically, in the embodiment, when the feature extraction model is trained, the feature extraction model training is completed when the PointInfo loss approaches 0.

The feature extraction model used in the data actively selection and annotation method for the point cloud in the present embodiment is obtained through the comparative learning-based training, and the obtained feature extraction model can effectively extract features.

Referring to FIG. 9, FIG. 9 is a schematic structure diagram of a classification model according to an embodiment of the present disclosure. In the embodiment, the classification model includes an encoding module and a feature classification module. The unannotated point cloud data with a label is inputted into the feature classification model, and a pseudo label of the unannotated point cloud data can be obtained. In the embodiment, the feature classification module is formed by a multi-layer fully connected network, and the normalized feature is inputted into the classification model to obtain a classification probability of the point cloud data. The classification model is trained by cross entropy, and parameters of the classification model obtained by training are fixed. The cross entropy is calculated as follows:

$${L}_{e} = - \frac{1}{N} {\sum }_{i} {\sum }_{j = 1}^{K} {y}_{ij} log ( {p}_{ij} ) ,$$

where K is the number of categories, yᵢⱼ is a symbol function, yᵢⱼ is taken as 1 when the sample i belongs to the category j, the rest is taken as 0; and pᵢⱼ is a prediction probability of an observation sample i belonging to the category j.

Specifically, in the embodiment, when the cross entropy tends to 0 during the training of the classification model, the training of the classification model is completed.

Through the classification model adopted by the data actively selection and annotation method for the point cloud in the embodiment, a pseudo label of the unannotated point cloud data can be calculated, which provides the support for calculating the annotation value of the unannotated point cloud data.

In the present embodiment, the to-be-annotated point cloud data is filtered from each target point cloud data through the active selection model according to the first feature, the second feature of each target point cloud data, and the pseudo label.

I In order to select the most valuable point cloud data that can maximize the promotion of the final classification effect to perform the annotation, in the embodiment, the selection indexes are respectively designed from the perspectives of the point cloud sample equilibrium, the point cloud feature richness, the uncertainty of the point cloud data and the like to select the unannotated point cloud data.

As for the index selection based on the uncertainty, since the spatial distribution is different, the ability of the point cloud selection model to identify different point cloud data is also different, and there may exist point cloud data which is more difficult to classify, and such point cloud data difficult to identify may greatly promote the training of the point cloud data selection model. Accordingly, it is first proposed to select such point cloud data difficult to identify as an evaluation index.

Specifically, the information entropy value is determined based on the pseudo label, and the unannotated point cloud data P′∈R^{N×3} is inputted into the classification model to obtain a corresponding classification prediction result, i.e., the pseudo label c∈R^{K}, and the information entropy of each point cloud data prediction result is denoted as q₁.

As for the index selection based on the feature richness, the richness of the information is also very important for the training of the point cloud data selection model. When the amount of the information in the training data is enough, the obtained point cloud data selection model can be ensured to have good performance. When the point cloud data are partially annotated, the contribution of other unannotated point cloud data to the overall amount of information may be different. The point cloud data with the most abundant information is selected to annotate, the richness of the information of the whole annotated data can be expanded, thereby facilitating the completion of the target task. The index can be obtained by the distance between the unannotated point cloud data feature and the annotated point cloud data feature. It is assumed that the unannotated point cloud data P is inputted into the comparative learning model and the obtained feature is fₚ, and the annotated point cloud data feature is fc. The index can be calculated by the following formula:

$${q}_{d} = dist ( {f}_{s} - {f}^{′} ) .$$

Through the selection of the index, the diversity of the features in the training sample, i.e., the unannotated point cloud data, can be fully expanded, and the performance of the point cloud data selection model can be effectively improved.

As for the index improvement based on the sample equilibrium. The sample category equilibrium has a great influence on the performance of the model, so that the equilibrium degree of the sample needs to be paid attention to in the process of filtering the point cloud data. It should be ensured that the filtered data is distributed evenly across the categories in order to prevent the point cloud data selection model from overfitting a category. Therefore, another consideration factor of the active learning strategy in the embodiment while ensuring the feature richness is the distribution of the sample amount of the annotated point cloud data, in order to further improve the index based on the feature richness. By considering only the distribution of point cloud features consistent with the labels in the calculation process, more attention is paid to the features of the sample categories. The classification is performed according to the real label of the original annotated data and the pseudo label of the unannotated data previously obtained, a classification label is denoted as s; the feature fₛ of the annotated point cloud data in the same category, i.e., the first feature, and the feature f′ of the unannotated point cloud data with the pseudo label s, that is, the second feature, may perform the calculation of the feature distance to obtain a score q₂.

In the present embodiment, the target feature distance between the second feature of each target point cloud data and the first feature is determined by using the classification label s representing a seat. Referring to FIG. 10, FIG. 10 shows a distribution of point cloud features in a mapping space. As shown in FIG. 10, there are two pieces of annotated point cloud data with real labels and three pieces of target point cloud data. The point cloud data in the dotted line box is point cloud data with a real label, and the rest is point cloud data with a prediction label identical to a real label.

Specifically, as for the second feature of each target point cloud data, the feature distance between the second feature and each first feature is represented in the figure by calculating with the formula (1), and the distances d1 to d6 between the three pieces of target point cloud data and the annotated point cloud data are calculated.

Specifically, as for the second feature of each target point cloud data, the minimum feature distance among the feature distances corresponding to the second features is determined, and the minimum feature distance serves as the target feature distance between the second features and the first features. As an example, as shown in FIGS. 10, d1, d3 and d5 respectively represent the target feature distance between three pieces of target point cloud data and two pieces of annotated point cloud data. For example, the feature distances from the target point cloud data (sofa) framed by the lowermost circular dotted line to the two pieces of annotated point cloud data is d5 and d6, respectively, and d5 is less than d6, then d5 serves as the target feature distance between the second feature of the target point cloud data and the first feature.

It can also be seen from the formula (3) that the greater the target feature distance is, the greater the annotation value of the target point cloud data is, and the target feature distance d5 is greater than d1 and d3. Accordingly, the data framed by the circular dotted line is likely to be the annotated point cloud data to be annotated next.

In the embodiment, the active selection model selects the to-be-annotated point cloud data by calculating the annotation value q of the unannotated point cloud data and the amount k_{c} of point cloud data needing to be annotated in a specific category.

Finally, the active selection model ranks the annotation values of the unannotated point cloud data in a descending order, and selects the first k_{c} pieces of point cloud data as the to-be-annotated point cloud data.

In order to verify the accuracy of the to-be-annotated point cloud data filtered by the point cloud data selection model in the present embodiment, the verification is performed through a point cloud segmentation task and a point cloud classification task.

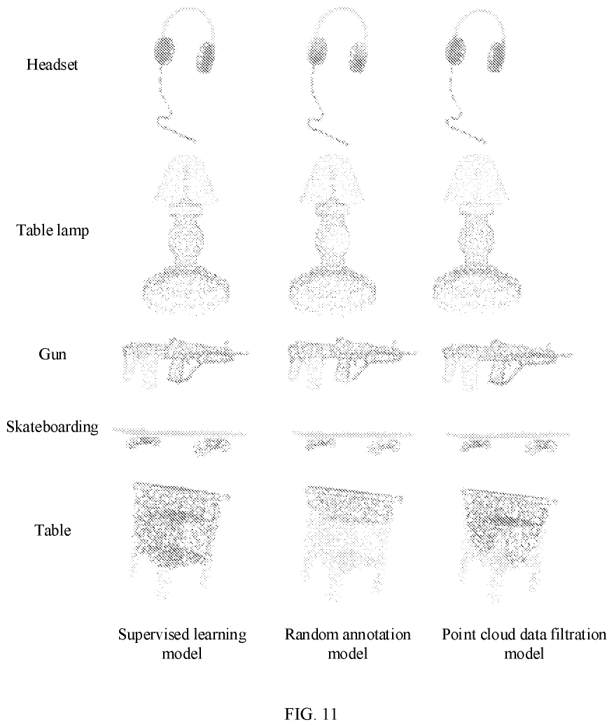

Referring to FIG. 11, FIG. 11 is a visual comparison diagram of segmentation effects in a point cloud segmentation task. The annotated point cloud data obtained by the monitoring model, the random annotation, and the point cloud data selection model in the present embodiment are compared in the segmentation task. As shown in FIG. 11, the point cloud data selection model in the present embodiment can reach the level of a supervised learning model in terms of the prediction results, while the random annotation method may affect the segmentation results of some categories and generate a segmentation error on the premise that only a small amount of data is annotated, especially for some categories with a small amount of data. Since the random selection does not take such target into account, the model is more difficult to predict the result of such target, resulting in an erroneous segmentation.

Referring to FIG. 12, FIG. 12 is a ModelNet classification accuracy variation diagram with a random annotation and an annotation using a point cloud data selection model. In order to verify the validity of the point cloud data selection model in the embodiment, ModelNet40 is selected as an experimental data set, and the ModelNet40 includes 40 three-dimensional models of different classifications; and a training set and a verification set are divided according to original forms thereof. The training set includes 9843 samples, and the verification set includes 2468 samples. By sampling each point cloud with FPS, the number of points inputted into the point cloud is fixed to 2048. The setting of the feature extraction model in the training process is as follows: the temperature parameter t is set to 0.07; a length of the built-in negative example pair buffer of the feature extraction model is set to 65536; a batch of order of magnitude inputted into the feature extraction model is 8; and after the same initialization operation is performed on two encoding modules with the same structure, the first encoding module is updated with the reverse transmission strategy, and the second encoding module is updated with the momentum, and a momentum update parameter of the second encoding module is 0.99. The whole training process of the feature extraction model adopts an Adam optimizer. For a learning rate, an equal-interval attenuation strategy is adopted. The initial learning rate is 0.001, an attenuation rate is 0.7, and an attenuation period is 20 rounds. The number of training rounds per iteration is set to 200, and 100 pieces of data are selected to be annotated each iteration.

W_{d} and Wₑ are both set to be 0.5 to train the point cloud data selection model, the accuracy of the test data is recorded after each iteration, and is compared to the random selection annotation method. As can be seen from FIG. 11 that when the amount of annotated data is smaller, the accuracy of the point cloud data selection model in the embodiment is substantially the same as that of the model trained by the random selection annotation strategy. This is because the feature extraction performance of the model on which the selection strategy is based is unsatisfactory when there is a smaller amount of annotated data in the early stage, and the feature at this moment is difficult to reflect the actual feature of the data itself. Therefore, the early effect is relatively consistent with the random selection annotation situation. As the number of iteration rounds increases, the number of annotated samples increases gradually. At this moment, the feature extraction capability of the point cloud data selection model obtained by training is greatly enhanced, and the extracted feature is representative to a certain extent, and the superiority of the active selection strategy begins to manifest itself, which can exceed the result of the random selection annotation on the test data. Subsequently, as the number of annotated data is further increased, the accuracy of the model of the active selection annotation is further increased, and the result of the random selection annotation tends to increase slowly and smoothly, and the difference between the active selection annotation and the random selection annotation is further widened. According to the data obtained in the experiments, in the case of training where close to 10% of the data is annotated, the accuracy of the point cloud data selection model is higher than the accuracy of the model of the random selection annotation by more than 20%, which proves the validity of the active selection strategy for the point cloud task.

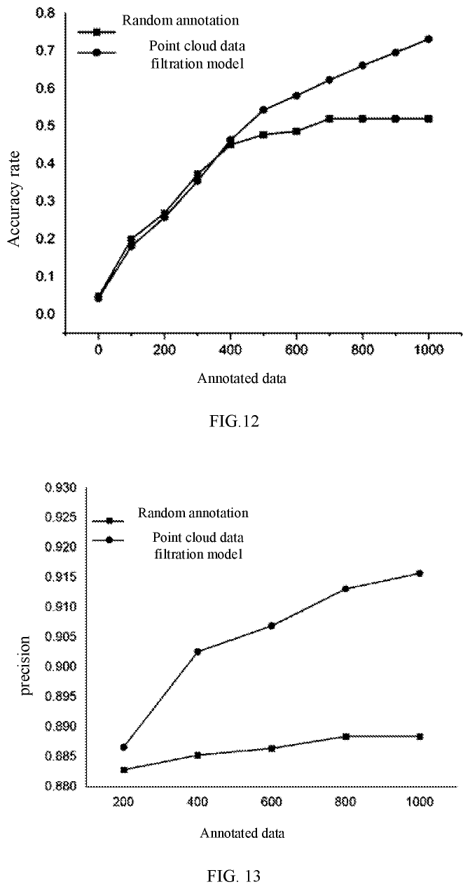

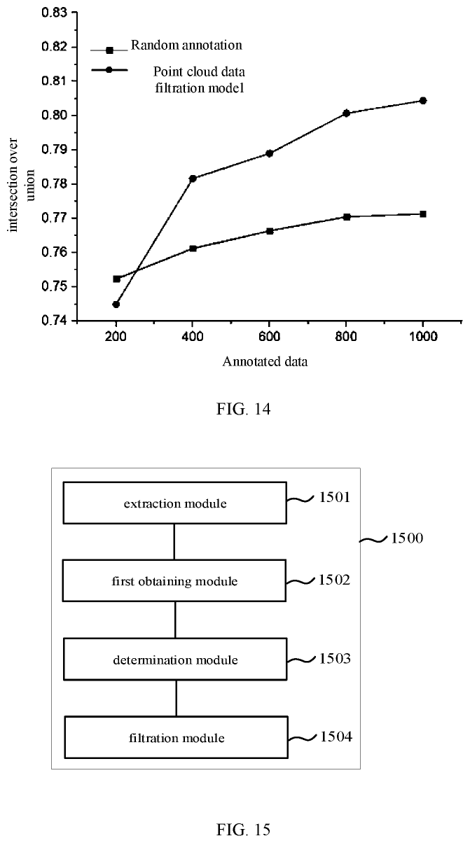

Referring to FIGS. 13 and 14, FIG. 13 is a ShapeNet mean accuracy variation diagram with a random annotation and an annotation using a point cloud data selection model according to an embodiment of the present disclosure; FIG. 14 is a ShapeNet mean intersection over union variation diagram with a random annotation and an annotation using a point cloud data selection model according to an embodiment of the present disclosure. As can be seen from FIGS. 13 and 14, the average accuracy and the mean intersection over union of the point cloud data selection model in the embodiment are better than the random annotation method.

According to the point cloud data selection model in the present embodiment, point cloud data with a higher annotation value in the unannotated point cloud data can be filtered out, and the manual selection can be replaced, thereby saving the time and labor cost. Moreover, the active selection model can effectively act on different point cloud data sets and has the universality. In addition, the accuracy, the average accuracy and the mean intersection over union of the point cloud data selection model are excellent.

It should be appreciated that although the steps in the flow charts referred to in the above embodiments are shown sequentially as indicated by arrows, these steps are not definitely performed sequentially as indicated by the arrows. Unless expressly stated herein, these steps are not definitely performed in a strict order but may be performed in other orders. Moreover, at least part of the steps in the flow charts referred to in the above embodiments may include a plurality of steps or phases, which are not definitely performed at the same moment, but may be performed at different moments, and the execution order of the steps or phases is not definitely in sequence, but may be performed in turns or alternately with other steps or at least part of the steps or phases in other steps or other stages.

Based on the same inventive concept, in an embodiment of the present disclosure, a data active selection and annotation apparatus for point cloud configured to implement the above-mentioned data active selection and annotation method for the point cloud. The technical solution provided by the apparatus is similar to the solution described in the above method. Therefore, for specific limitations of the data active selection and annotation apparatus for the point cloud, reference can be made to the above limitations of the data active selection and annotation method for the point cloud, which will not be repeated herein.

In an embodiment, as shown in FIG. 15, FIG. 15 is a structure diagram illustrating a data active selection and annotation apparatus for point cloud according to an embodiment of the present disclosure. The apparatus 1500 includes:
an extraction module 1501, configured to input initial point cloud data into a feature extraction model to extract a first feature of annotated point cloud data and a second feature of unannotated point cloud data, in which the initial point cloud data includes the annotated point cloud data and the unannotated point cloud data;
a first obtaining module 1502, configured to input the unannotated point cloud data into a classification model to obtain a classification result of the unannotated point cloud data;
a determination module 1503, configured to determine each piece of target point cloud data with a pseudo label identical to a real label from the unannotated point cloud data according to the classification result and the real label of the annotated point cloud data;
a selection module 1504, configured to filter to-be-annotated point cloud data from each piece of target point cloud data according to the first feature, a second feature and the classification result of each piece of target point cloud data.

In an embodiment, the selection module 1504 further includes:
a determination submodule, configured to determine a target feature distance between the second feature of each piece of target point cloud data and the first feature;
a selection submodule, configured to filter the to-be-annotated point cloud data from each piece of target point cloud data according to each target feature distance and the classification result.

In an embodiment, the selection submodule includes:
a first determination unit, configured to determine an information entropy value of each piece of target point cloud data according to the classification result of each piece of target point cloud data;
a second determination unit, configured to determine an annotation value of each piece of target point cloud data according to the target feature distance and the information entropy value of each piece of target point cloud data;
a selection unit, configured to filter the to-be-annotated point cloud data from each piece of target point cloud data according to the annotation value of each piece of target point cloud data.

In an embodiment, the selection unit is specifically configured to filter the to-be-annotated point cloud data from each piece of target point cloud data according to a first quantity of each piece of target point cloud data, a second quantity of the initial point cloud data, and the annotation value of each piece of target point cloud data.

In an embodiment, the selection unit is specifically configured to determine a ratio of the first quantity to the second quantity, determine a third quantity of the to-be-annotated point cloud data according to the ratio and a preset point cloud data annotation quantity threshold, and filter the third quantity of to-be-annotated point cloud data from each piece of target point cloud data.

In an embodiment, the determination submodule is specifically configured to determine a feature distance between a second feature of each piece of target point cloud data and each first feature.

In an embodiment, the determination submodule is specifically configured to determine a minimum feature distance corresponding to the second feature of each piece of target point cloud data, and determine the minimum feature distance as the target feature distance between the second feature and the first feature.

In an embodiment, the apparatus may further include:
a second obtaining module, configured to input a point cloud data sample into a first encoding module to obtain first encoded data, and input the first encoded data into a first projection module to obtain a first normalized feature at a current iteration;
a transformation module, configured to perform coordinate transformation processing on the point cloud data sample to obtain a point cloud data sample processed by the coordinate transformation;
a third obtaining module, configured to input the point cloud data sample processed by the coordinate transformation into the second encoding module to obtain second encoded data, and input the second encoded data into a second projection module to obtain a second normalized feature at a current iteration;
a comparison module, configured to determine the first normalized feature and the second normalized feature as a positive example pair, and determine the first normalized feature and each second normalized feature obtained before the current iteration as a set of negative example pairs;
a training module, configured to train the initial feature extraction model according to the positive example pair and the set of negative example pairs to obtain a feature extraction model.

Various modules in the above-described data active selection and annotation apparatus for the point cloud may be implemented in whole or in part by software, hardware, and combinations thereof. The modules may be embedded in or independent of a processor in a computer device in hardware, or may be stored in a memory of a computer device in software to facilitate the processor to invoke and perform operations corresponding to the modules.

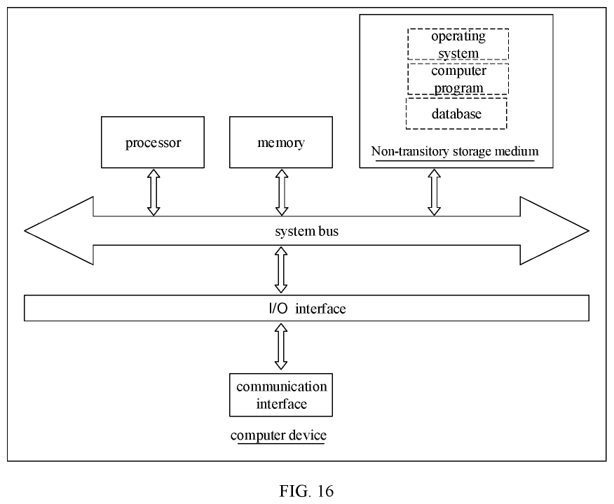

In an embodiment, a computer device is provided, which may be a server, the internal structure of which may be shown in FIG. 16. The computer device includes a processor, a memory, and a network interface connected by a system bus. The processor of the computer device is configured to provide computing and control capabilities. The memory of the computer device includes a non-transitory storage medium and an internal memory. The non-transitory storage medium stores an operating system, a computer program, and a database. The internal memory provides an environment for the operation of the operating system and the computer program in a non-transitory storage medium. The database of the computer device is configured to store the data filtered from the point cloud data. The network interface of the computer device is configured to communicate with external terminals through a network connection. The computer program is executed by the processor to implement a data active selection and annotation method for point cloud.

It should be appreciated by those skilled in the art that the structure shown in FIG. 16 is a block diagram of partial structure relevant to the solution of the present disclosure, and does not constitute a limitation to the computer device to which the solution of the present disclosure is applied; and a specific computer device may include more or less components than those shown in the figures, or may combine certain components, or have a different component arrangement.

In an embodiment, a computer device is provided, which includes a processor and a memory storing a computer program, the processor, when executing the computer program, performs the following steps of:
inputting initial point cloud data into a feature extraction model to extract a first feature of annotated point cloud data and a second feature of unannotated point cloud data, in which the initial point cloud data includes the annotated point cloud data and the unannotated point cloud data;
inputting the unannotated point cloud data into a classification model to obtain a classification result of the unannotated point cloud data;
determining each piece of target point cloud data with a pseudo label identical to a real label from the unannotated point cloud data according to the classification result and the real label of the annotated point cloud data;
filtering to-be-annotated point cloud data from each piece of target point cloud data according to the first feature, the second feature of each piece of target point cloud data, and the classification result.

In an embodiment, a computer-readable storage medium is provided, on which a computer program is stored, the computer program, when executed by a processor, causes the processor to implement the following steps of:
inputting initial point cloud data into a feature extraction model to extract a first feature of annotated point cloud data and a second feature of unannotated point cloud data, in which the initial point cloud data includes the annotated point cloud data and the unannotated point cloud data;
inputting the unannotated point cloud data into a classification model to obtain a classification result of the unannotated point cloud data;
determining each piece of target point cloud data with a pseudo label identical to a real label from the unannotated point cloud data according to the classification result and the real label of the annotated point cloud data;
filtering to-be-annotated point cloud data from each piece of target point cloud data according to the first feature, the second feature of each piece of target point cloud data, and the classification result.

It should be noted that the user information (including, but not limited to, user device information, user personal information, and the like) and data (including, but not limited to, data for analysis, stored data, displayed data, and the like) related to the present disclosed are information and data that are authorized by the user or sufficiently authorized by each party.

It should be appreciated by those of ordinary skill in the art that all or part of the procedures of implementing the methods in the embodiments described above may be accomplished by a computer program instructing relevant hardware, and the computer program may be stored in a non-transitory computer-readable storage medium and which, when executed, may include the procedures in the embodiments of the methods described above. Any reference to a memory, database, or other medium used in the embodiments provided herein may include at least one of non-transitory memory and transitory memory. The non-transitory memory may include a Read-Only Memory (ROM), a magnetic tape, a floppy disk, a flash memory, an optical memory, a high-density embedded non-transitory memory, a resistive random access memory (ReRAM), a Magnetoresistive Random Access Memory (MRAM), a Ferroelectric Random Access Memory (FRAM), a Phase Change Memory (PCM), a graphene memory, and the like. The transitory memory may include a Random Access Memory (RAM) or an external cache memory or the like. By way of illustration and not limitation, the RAM may be in a variety of forms, such as a Static Random Access Memory (SRAM) or a Dynamic Random Access Memory (DRAM). The databases referred to in the embodiments provided herein may include at least one of a relational database and a non-relational database. The non-relational database may include a block chain-based distributed database or the like, and is not limited thereto. The processor involved in the embodiments provided herein may be a general-purpose processor, a central processing unit, a graphics processor, a digital signal processor, a programmable logic unit, a quantum computing-based data processing logic unit, or the like, and is not limited thereto.

Each of the technical features in the above embodiments may be combined arbitrarily. For the sake of brevity, all possible combinations of each of the technical features in the above embodiments are not described. However, the combinations of these technical features should be considered to be within the scope of the present description as long as they do not contradict each other.

The above embodiments represent only a few implementation modes of the present disclosure, are described in more detail and detail, but are not therefore to be construed as limiting the scope of the present disclosure. It should be noted that several variations and modifications may be made by those of ordinary skill in the art without departing from the spirit and scope of the present disclosure. Accordingly, the scope of protection of the present disclosure should be subject to the appended claims.

What is claimed is:

1. A data active selection and annotation method for a point cloud, comprising:
inputting initial point cloud data into a feature extraction model to extract a first feature of annotated point cloud data and a second feature of unannotated point cloud data, the initial point cloud data comprising the annotated point cloud data and the unannotated point cloud data;
inputting the unannotated point cloud data into a classification model to obtain a classification result of the unannotated point cloud data;
determining each piece of target point cloud data with a pseudo label identical to a real label from the unannotated point cloud data according to the classification result and the real label of the annotated point cloud data, the pseudo label being determined according to the classification result; and
filtering to-be-annotated point cloud data from each piece of target point cloud data according to the first feature, the second feature and the classification result of each piece of target point cloud data.

2. The data active selection and annotation method for the point cloud according to claim 1, wherein the filtering the to-be-annotated point cloud data from each piece of target point cloud data according to the first feature, the second feature and the classification result of each piece of target point cloud data comprises:
determining a target feature distance between the second feature of each piece of target point cloud data and the first feature; and
filtering the to-be-annotated point cloud data from each piece of target point cloud data according to the target feature distance and the classification result.

3. The data active selection and annotation method for the point cloud according to claim 2, wherein the filtering the to-be-annotated point cloud data from each piece of target point cloud data according to the target feature distance and the classification result comprises:
determining an information entropy value of each piece of target point cloud data according to the classification result of each piece of target point cloud data;
determining an annotation value of each piece of target point cloud data according to the target feature distance and the information entropy value of each piece of target point cloud data; and
filtering the to-be-annotated point cloud data from each piece of target point cloud data according to the annotation value of each piece of target point cloud data.

4. The data active selection and annotation method for the point cloud according to claim 3, wherein the filtering the to-be-annotated point cloud data from each piece of target point cloud data according to the annotation value of each piece of target point cloud data comprises:
filtering the to-be-annotated point cloud data from each piece of target point cloud data according to a first quantity of each piece of target point cloud data, a second quantity of the initial point cloud data, and the annotation value of each piece of target point cloud data.

5. The data active selection and annotation method for the point cloud according to claim 4, wherein the filtering the to-be-annotated point cloud data from each piece of target point cloud data according to the first quantity of each piece of target point cloud data, the second quantity of the initial point cloud data, and the annotation value of each piece of target point cloud data comprises:
determining a ratio of the first quantity to the second quantity;
determining a third quantity of the to-be-annotated point cloud data according to the ratio and a preset point cloud data annotation quantity threshold; and
filtering the third quantity of to-be-annotated point cloud data from each piece of target point cloud data.

6. The data active selection and annotation method for the point cloud according to claim 2, wherein the determining the target feature distance between the second feature of each piece of target point cloud data and the first feature comprises:
determining a feature distance between the second feature of each piece of target point cloud data and each first feature;
determining a minimum feature distance corresponding to the second feature of each piece of target point cloud data, and determining the minimum feature distance as the target feature distance between the second feature and the first feature.

7. The data active selection and annotation method for the point cloud according to claim 1, further comprising:
inputting a point cloud data sample into a first encoding module to obtain first encoded data, and inputting the first encoded data into a first projection module to obtain a first normalized feature at a current iteration;
performing coordinate transformation processing on the point cloud data sample to obtain a point cloud data sample processed by the coordinate transformation;
inputting the point cloud data sample processed by the coordinate transformation into a second encoding module to obtain second encoded data, and inputting the second encoded data into a second projection module to obtain a second normalized feature at a current iteration;
determining the first normalized feature and the second normalized feature as a positive example pair, and determining the first normalized feature and each second normalized feature obtained before the current iteration as a set of negative example pairs;
training the initial feature extraction model according to the positive example pair and the set of negative example pairs to obtain the feature extraction model.

8. A data active selection and annotation apparatus for a point cloud, comprising:
an extraction module, configured to input initial point cloud data into a feature extraction model to extract a first feature of annotated point cloud data and a second feature of unannotated point cloud data, the initial point cloud data comprising the annotated point cloud data and the unannotated point cloud data;
a first obtaining module, configured to input the unannotated point cloud data into a classification model to obtain a classification result of the unannotated point cloud data;
a determination module, configured to determine each piece of target point cloud data with a pseudo label identical to a real label from the unannotated point cloud data according to the classification result and the real label of the annotated point cloud data;
a selection module, configured to filter to-be-annotated point cloud data from each piece of target point cloud data according to the first feature, a second feature and the classification result of each piece of target point cloud data.

9. A computer device, comprising a processor and a memory storing a computer program, wherein the processor, when executing the computer program, implements the method of claim 1.

10. A computer-readable storage medium, on which a computer program is stored, wherein the computer program, when executed by a processor, causes the processor to implement the method of claim 1.
